(19) United States
(12) Patent Application Publication
(10) Pub. No.: US 2013/0326373 A1
(43) Pub. Date: Dec. 5, 2013

(54) System and Method for Displaying Social Network Interactivity with a Media Event

(71) Applicant: Star*Club Ltd, Malibu, NY (US)

(72) Inventors: Zach Lisabeth, Los Angeles, CA (US); Ben McAllister, Los Angeles, CA (US); Max Klein, Los Angeles, CA (US); Andreas Neumann, Los Angeles, NY (US); Ted Sabety, New York, NY (US)

(21) Appl. No.: 13/962,286

(22) Filed: Aug. 8, 2013

Related U.S. Application Data
(63) Continuation-in-part of application No. 13/327,513, filed on Dec. 15, 2011.
(60) Provisional application No. 61/859,525, filed on Jul. 29, 2013.

(51) Int. Cl. H04L 12/58

(52) U.S. Cl. CPC H04L 51/32
USPC 715/753

(57) ABSTRACT

A system for presenting a media event on a computer display device is disclosed, where the audience for the media event are represented by avatars that are displayed on the user's computer as geometric shapes or bubbles that float about the region surrounding the window presenting the event. System logic determines which of the audience bubbles are visible in the space and further causes avatars for advertising to appear. In one embodiment the viewing user can select which other users are visible on their screen based on user selectable filtering inputs. A moderating panel function permits a performing artist to control what content, advertising and merchandising is displayed as part of the event and the surrounding user environment.

### PRIORITY CLAIM

This disclosure incorporates by reference U.S. patent application Ser. No. 13/327,513 filed on Dec. 15, 2011. This disclosure claims priority as a continuation in part to U.S. patent application Ser. No. 13/327,513 filed on Dec. 15, 2011, and claims priority as a nonprovisional continuation of provisional patent application U.S. Pat. App. No. 61/859,525 filed on Jul. 29, 2013 and incorporates both off those applications by reference in their entireties.

### SUMMARY OF THE INVENTION

Social networking Internet websites have become very popular. However, social network websites have not integrated well with centralized sources of media entertainment. In some cases, on-line events are presented to a website displayed in a browser while in a separate window, the social networking application is operated. However, it is not clear to users who are viewing the entertainment, who else is viewing the vent because they are separate applications. In this invention, the social networking platform is integrated into a media entertainment display channel and process so that the audience can enjoy the on-line entertainment while interacting socially in a more fluid way. In the preferred embodiment of the invention, the system provides a user environment that appears in a browser screen or any typical program window displayed on the user's computer device. The user environment appears to be comprised of floating bubbles (a bubble is an ovoid or circle) and a media box (typically in the center) that can display a live camera, a stream or a playlist of videos for the performance of featured content, referred to as an event. In one embodiment, there are four types of floating bubbles—a user profile bubble, an advertiser bubble, a media bubble and a merchandise bubble. The event will have many users who attend the event, in the sense that the user's computers are provided access to the media content that will be displayed in the media box portion of the display. In addition, these users' bubbles will appear on the display screens of the other users who also are logged into the event.

The event is controlled by a moderator or host, which controls the environment through another system component that displays on his/her computer screen a ‘Moderator Panel’ and a CMS or content management system. The moderator can edit, insert, and control the environment during event, but can also do it before the event begins, for example, by selecting media for display as the content.

In the preferred embodiment there are at most some predetermined maximum number of bubbles visible on the screen, typically 150 bubbles. Not all users attending the event can see all other users. The bubbles preferably never stand still—they always float even when not floating through the screen. Users may control the speed of the bubbles floating around. As a result, a faster speed results in more bubbles floating in and out of screen per minute and a slower speed, less. Users can control the relative perspective in order to either zoom in (to see more bubbles) or zoom out (to see less bubbles). A user always sees their own bubble in their screen. Advertiser, merchandise, and media bubbles and the viewing user bubble profile float around the screen without exiting until removed or when the user logs out of the event. Users can customize their experience to view only bubbles associated with users attending the event that meet a selected filtering characteristic, for example, only other users they know, or only users within a set distance of a certain geo-location. If a user wants to view more information about another user whose bubble appears on the screen, they can hover the computer cursor, or their finger that bubble, which will then expand and brighten to show data the other user is prepared to present publicly, for example, a larger image of the person, their alias or handle, their interests or any other information they are prepared to openly share.

### BRIEF DESCRIPTION OF THE DRAWINGS

FIG. 1 Basic system architecture.

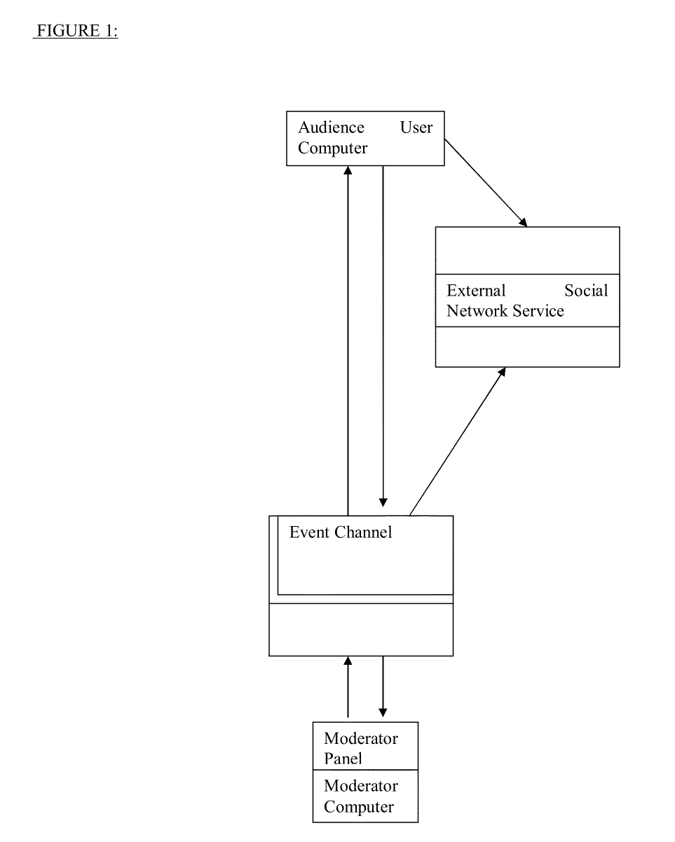

FIG. 2. Example User Environment

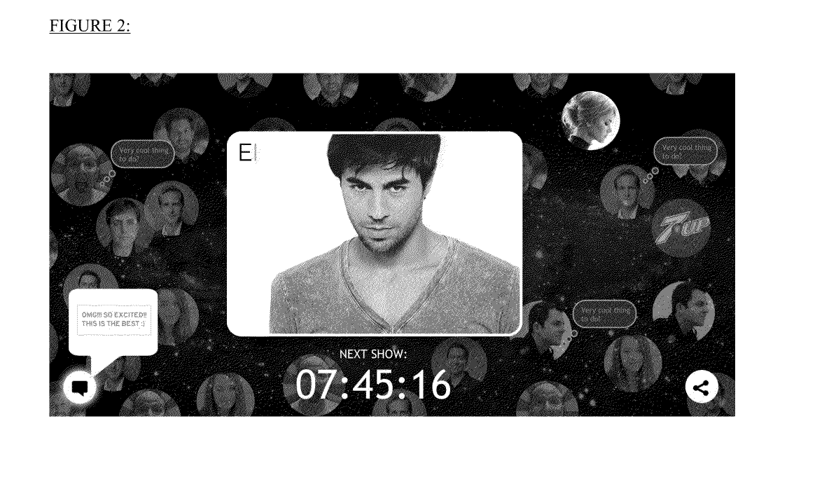

FIG. 3. Example Moderator Panel.

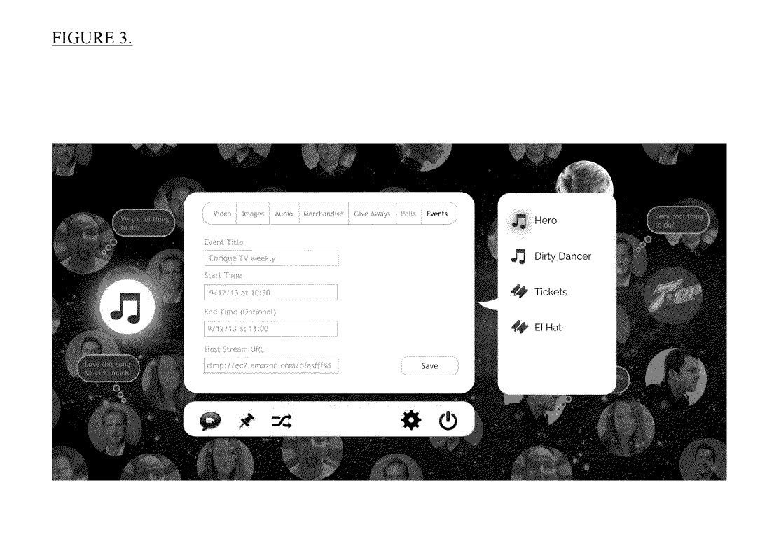

FIG. 4. Schematic of User to User interactivity functions.

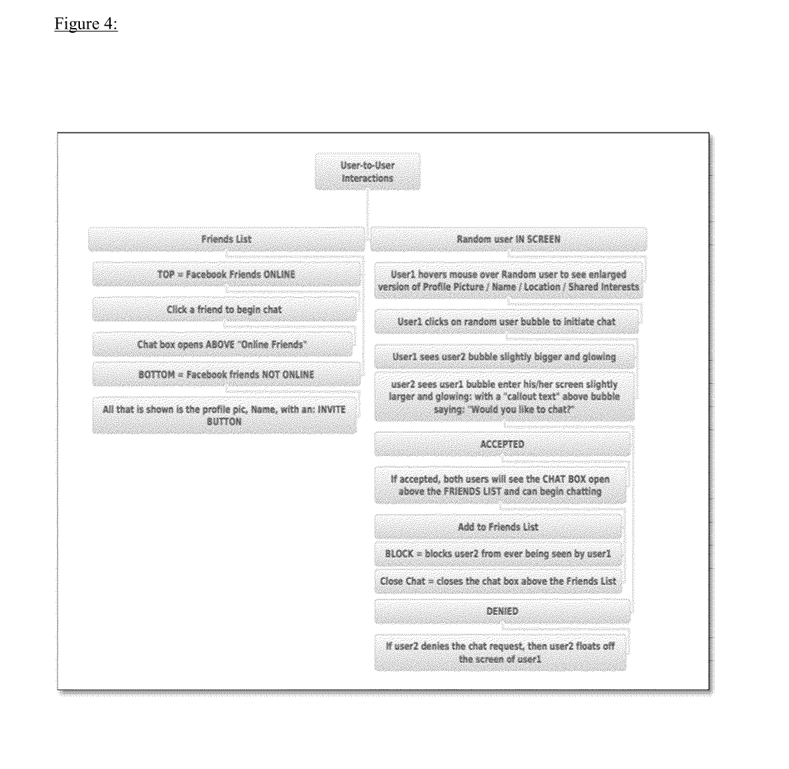

FIG. 5. Schematic of Star/Moderator to User interactivity functions.

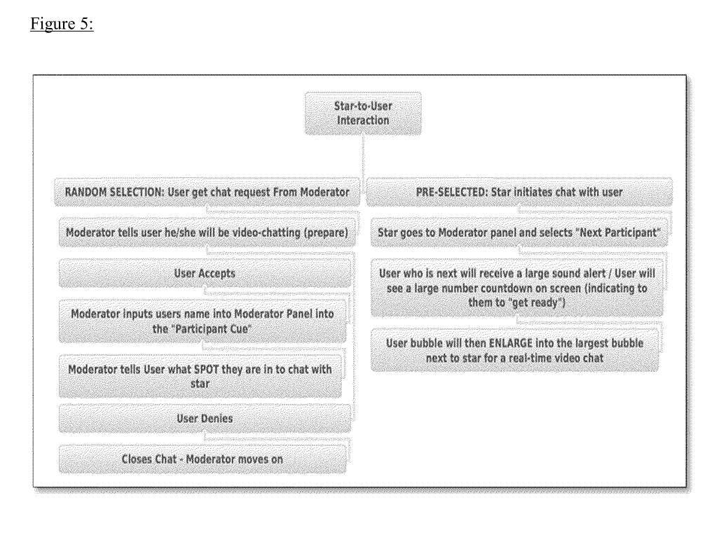

FIG. 6. Schematic of moderator functionality.

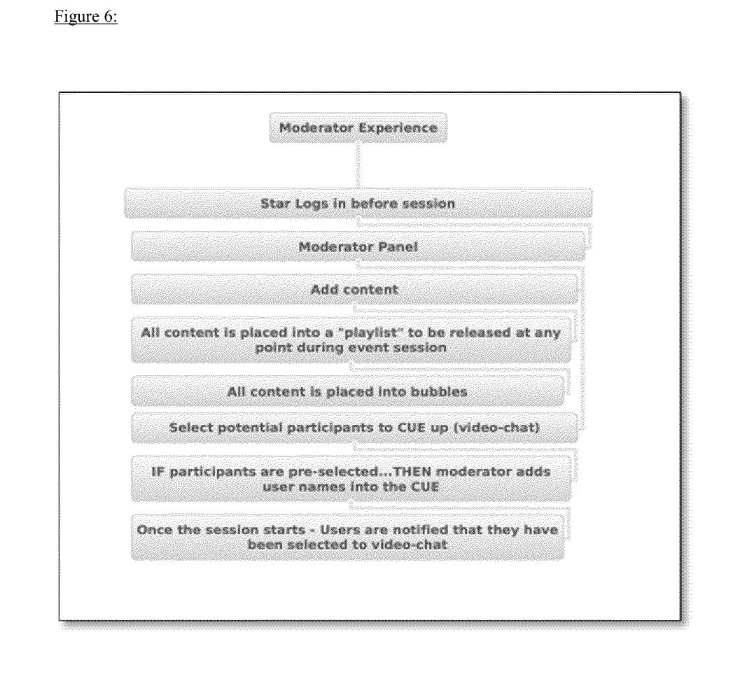

FIG. 7. Schematic of user interactivity functionality.

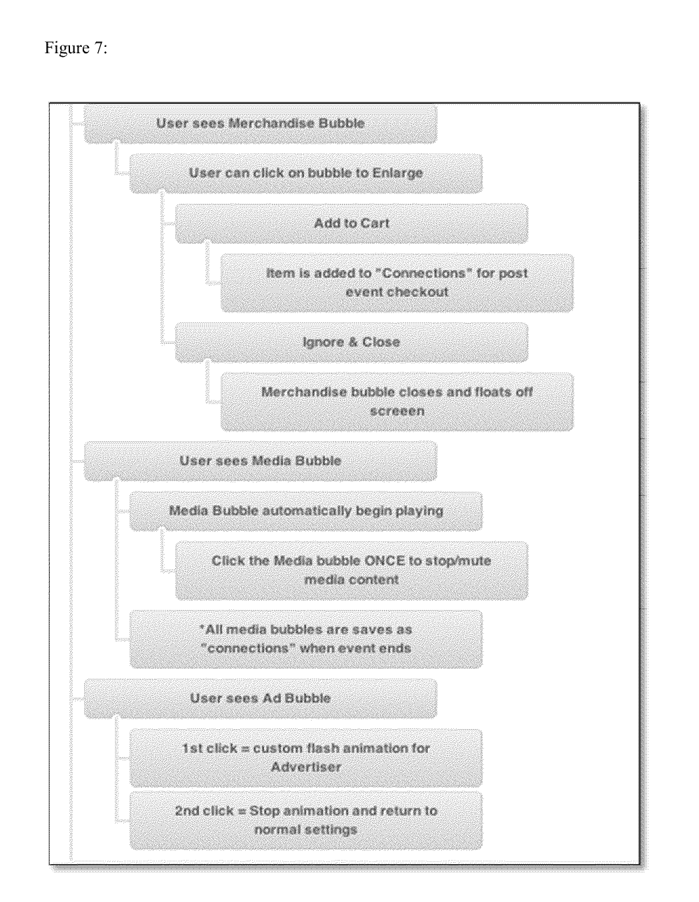

### DETAILED DESCRIPTION OF THE PREFERRED EMBODIMENTS

The system is comprised of one or more servers that are connected over a data network with one or more client devices. The client devices may be user computers or similar mobile devices operating an Internet browser program. In another embodiment, the user device is operating a computer program designed to display the user environment, for example, as a mobile app. The browser program is directed to access a specific URL (Universal Resource Locator) associated with a specific on-line media event. In one embodiment, the media event is a streamed concert of a musical performer. The streaming may originate from the servers or may originate from some other server but be referenced by code or another URL transmitted to the user's computer.

The servers transmit to the user's computer data that can be used by the user's computer to display the user environment, by, for example, rendering a webpage that presents the environment in which the on-line media event is displayed. In the preferred embodiment, the on-line media is an audio-visual presentation streamed to a window that lies within the boundary of the browser window. The social interactivity arises from users who log into the system to activate the media stream by means of their social networking application log-in. These users input a permission value into their browser that is then transmitted to the servers hosting the social networking application. As a result, the invention is able to access the user's social networking image. In another embodiment, the image can be uploaded directly to the system by the user.

Users can attend a live streaming event where they can shop, have the opportunity to chat with the entertainer through video or text, share events to all of their friends at other social networks and more all without ever leaving the event. The video interface allows any type of video content to be displayed to the users, including music videos or any other pre-produced content so that in the breaks between live streaming events additional entertainment can be provided. The technology also supports custom contests and competitions with free digital content as rewards for users making a commitment to the brand by way of signing up or providing personal details.

As users log into the media event, information relevant to presenting their bubbles on other user's computers are transmitted out from the server to all of the users that are logged into the same event. This is accomplished by transmitting out to each browser that is accessing the webpage through which the media content is presented, references and scripts that are used by the local browser to render the user bubble and any chat text that is to be displayed with it. As a result, the appearance to the other users is a browser window with a smaller window within it that displays the media event, and the surrounding region displaying bubbles representing a sub-set of all of the users attending the media event. In another embodiment, the architecture can be peer to peer, so that each user's computer can transmit the relevant bubble data to the IP addresses of all of the other user's computers.

User Environment: One of the most important features of the invention is that the users that log-in to view a particular media event are represented in the display as an image or icon or avatar that is presented in the display region surrounding the media content display. In the preferred embodiment, the bubbles may be circular, ovoid or have the appearance of a sphere. However, any kind of geometrical shape may do as the shape of the icon or avatar. The icons or avatars, referred to as “bubbles” may float about randomly or be moved by a user by means of various functional commands that are input into the browser. Each bubble has a texting or chat function associated with it.

In one embodiment, the user environment will present several types of bubbles:

1. User Bubble: User logs in through Facebook and it turns their profile picture into a user bubble. When a user places a cursor or finger or other graphical user interface pointing mechanism over a user bubble, it enlarges and pulsates and shows a larger profile image and data about the other user that such other user is willing to publicly present, for example, an alias, interests, location or any other data that such user is willing to share.
2. Advertiser Bubble: Advertiser bubbles will be prepopulated within every Bubble event. These Ad bubbles will be highly interactive, but without disrupting the user experience.
3. Media Bubbles which are Moderator Controlled: Media bubbles will consist of Music, Video, and Image based content that the moderator can initiate and thereby transmit out to all the users during the event. The bubble data structure may include a URL, so that when the bubble is clicked on by the user, the URL is activated to initiate a stream of content to the user's computer.
4. Merchandise Bubble which are also Moderator Controlled: Similar to the Media Bubbles, Merchandise Bubbles are prepopulated within the moderator panel and can be released to the user audience at anytime. The release mechanism is that relevant data for rendering such a bubble is transmitted out from the servers to all of the user's who are logged into the event. The user's computers receive this data and then render the merchandise bubbles. For example, the server may transmit an image, some text and a hyperlink for a pair of shoes. These Merchandise Bubbles represent tangible items that a user can view, and purchase. Each Merchandise Bubble that a user interacts with is saved and available for immediate purchase after event is over.

The system can be configured to provide a communications channel between external instant messaging platforms. In one embodiment, the Twitter™ account of one or more users can be interfaced with the system in order that messages related to the event are displayed in or with the bubbles. In another embodiment, the system provides an interface, either through the webpage or some API, an input mechanism so that a user can input a chat message that is broadcast out to all of the other users who are logged-in to the same media event, so as to show the message floating in connection with that user's bubble. The chat message input into the browser is transmitted from the user's computer up to the server and then broadcast out to the other user's computers that are accessing the event.

The chat functionality has an added mode of permitting private chats between a first user operating the browser and a second user whose bubble appears on the first user's display. In this embodiment, the first user actuates a control in the user interface that causes the system to establish a private chat channel between the first user and the second user. In one embodiment, this control is actuated by moving a cursor over the second user's bubble so as to hover above it, and then as a result, the system displays a box that can be clicked on so as to cause the channel to be initiated. When the channel is initiated, the chat text input into the browser it only transmitted to the display of the second user. If the second user responds, then that chat input by the second user into the second user's browser is only transmitted via the server to the display of the first user.

To initiate a chat, all a user needs to do it click on another user bubble. The user's bubble who initiated the chat will begin pulsating on the recipient's screen with a “callout chat” above the bubble. Both users will see on their display a small notification on their CHAT ICON. The user who was initiated can either click on the users pulsating bubble OR they can click on their chat icon. Both functions open the chat icon into the slideout/dropdown mode. If a user(A) wants to initiate a chat with another user(B), but user(A) is not visible on user(B)'s screen, then, when clicked: User(A)'s bubble automatically begins to move into the screen view of User(B) with the “Callout text” above their bubble. Both User(A) and User(B) see their “CHAT ICON” blinking with a notification. User(B) has the option to accept or deny the chat session. If User(B) accepts, then user (B) clicks on their CHAT ICON. If user (B) denies the chat connection, user(a)'s CHAT ICON stops blinking with a notification. Within a chat, users will have the option (within the chat box) to add the other user to their friends list or block that user, in which case the user who was blocked will never appear on the other user's environment screen again.

The invention further integrates with social networking platforms by providing a mechanism for users to transmit to other individuals that are users of the social networking platform a data message representing an invitation to attend or access the media event. A user can authorize the system to access a commercial social networking website using the log-in information of the user to automatically obtain the user's information regarding that user's social connections on that social media platform. A user can invite their social network friends, and those invitees come in, but the system stores in its database data that indicates who the inviting user was. As a result the system can start creating a social graph from the data, and can figure who is a friend of the user, or other users once, twice or any number of times removed.

User Filtering. An important part of the functionality of the system is the determination of which users that are in the audience for the media event will be displayed on a given user's screen. The system provides a variety of selection mechanisms that can be controlled by each user. In one embodiment, the other audience members are selected based on their relative friendship distance from the user. For example, a user can specify that the only bubbles to display are other users who are no more than two degrees of separation from the user. This would result in a screen displaying the bubbles of members of the audience who have either a direct relationship with the user, or have a direct relationship with other people who have a direct relationship with the user. This would be two degrees of separation. In one embodiment, the selection of the amount of separation is input by using a slide bar, where on the one side, there is no degree of separation and on the other some larger number, for example 6 degrees of separation.

In yet another embodiment, the filter can be set to only choose other users whose geographic location is within some predetermined distance to the location of the user. Likewise, a slider control can be presented to the user as part of the GUI where on one end, there is the minimum distance and the other, maximum distance. Other filter criteria may be used as well, for example, male or female, gay or straight or age. The slider control for age may have to handles, one for minimum age and the other for maximum age. A slider can select on the basis of percentage of strangers vs. friends or friends of specified degrees. The filter criteria may be combined, such that the sliders can set a customized filter to provides for all people within 3 degrees of separation, who reside within 30 miles, who are male or female, who are straight, who are between 18 and 25 years of age.

One particularly important filter is the reciprocation filter. Given a first and second user, it may be that the first user has set up filtering criteria that will include the second user. In addition, the second user may have set up their own filtering criteria that includes the first user. Yet the first and second user may not know each other. The reciprocation filter then selects those bubbles on the first user's display (which by definition meet the first user's filter) whose users have set their filter to include the first user. By means of the chat function, the first user can then initiate a contact with such users.

Filtering by Ranking Algorithm. In another embodiment, the system can match users by filtering on the basis of location, interests, friend networks, gender, sexual orientation and any other relevant criteria. A weighting calculation can create a score that, for a given user, ranks the other users attending an event. In one example embodiment, a ranking score can be calculated as a linear combination of numerical values representing the amount or presence of some characteristic whereby the coefficients of each term are the weightings for such characteristics. Variables that can be used in calculating the ranking include:

Likes

Interests

Groups or Networks (i.e.: Schools, Employment, etc.)

Facebook friends & Friends of Friends

Location

Past location check-ins

In one example embodiment, first select users within a predetermined distance from the user, for example, 50 miles from the viewing user, taking users within that radius and giving them a rating based on their relevance to the viewing user. Relevance is calculated using the variables, including Shared friends, shared interests, locations.

The filter criteria settings are transmitted from the user's browser to the server. The server compares the filter criteria setting to the attributes associated with the other users who are logged into the same media event. Only bubble data associated with those users who fit the criteria for a given user have their bubble data transmitted to that user's device. In addition, the server, which is tracking which user's bubble data have already been transmitted to a user's device, transmits a data message to the filtering user's computer in order to cause the computer to delete the bubbles that are filtered out of the filter setting. As a result, the selected bubbles for the other users may be selected and displayed. In addition, these bubbles may randomly float in and around the screen, appearing and disappearing. By using the ranking calculation in addition to the random selection and movement, certain of the other users may be prioritized on the viewing user's screen. This can be accomplished by cycling so that the users are divided by time for display, further divided by time so that each user has a chance to interact with the viewing user.

Other selection criteria include time cycling, characteristic filtering, specifically by user input or by media event host input, by determinations of commercial activity of a user. In the case of commercial activity, the user's activities can be used to rank them for their likelihood to appear in the space. For example, a user that has purchased merchandise is more valuable than one that has not. Or one that has clicked on advertising is more valuable than one that has not. Various metrics can be calculated using activity data. For example, the total amount of merchandise value purchase in a prior period of time, or the number of advertising clicks. These metrics can be combined to create a ranking number for each user accessing the media event. Other metrics can be included in the calculation of rank, for example, whether the user has transmitted a like command for the artist associated with the event, or a twitter message containing a link to the event, an invitation to their social network connections, a like indication to their social network connections or other similar actions.

Content Management System: The system has a master content management mode in which authorized users of the system, referred to as moderators, can easily add new channels, new events, see all registered users, all interactions, and control the moderator panel and future features to be added to the platform. In addition the system presents to the authorized user a graphical user interface that operates as the Moderator Panel, which is a front-end panel accessible to all moderators before, during, and after each event. A moderator can manage event controls, select media file feeds for transmission out to users as an event, camera and audio feeds, view users who are logged in as audience members, upload new media files into the system, change the background image, and set privacy settings.

Scheduling new events: Each moderator has the ability to add and schedule an events for their fan-base. An event may be time-sensitive and promoted via the moderator's marketing channels. These can be by banner advertising, social media broadcast and the like. When setting up a new event the moderator will select from the moderator panel a reference to media content to be transmitted out to the audience user computers. In one embodiment, the moderator selects a reference to a URL for a media stream, which is then transmitted out to the user computers and embedded in the center media box of the user environment graphical user interface. Users that subscribe to the moderator can set reminders for when the event is to take place.

Uploading media. Moderators will be able to launch various media bubbles in the form of Music, Video, and Images. Before the event begins, any Moderator will be able to access their respective moderator panels and add new content that they then can release out to the user audience computers during their events that are delivered to the media box within the user's displays. Each piece of media uploaded is stored in a database that when the moderator so chooses, can be used to locate the content and place it into a playlist, which will have a start time associated with it so that the system can cause the media to be played on the user's computers at that time.

Uploading Merchandise. The moderator panel permits the moderator to select from a list of references to merchandise that can be promoted through the event. When a moderator clicks on a reference to the merchandise, the system then creates a data message containing references to the merchandise, which may include its name, an image, text about the merchandise and a hyperlink to a location to find out more information or purchase the merchandise. This message is transmitted out to the users so as to cause the user environment graphical user interface to create and display an merchandise bubble.

Media & Merchandise Bubbles are prepopulated or uploaded in real-time within the moderator panel and can be released to the event audience at anytime. These bubbles contain links to permit the users to pre-view the media or merchandise and links to purchase the item. In one embodiment, for a music media bubble, these are configured to begin playing on the user's computer as soon as they are activated by the moderator. The user interface is configured to stop the playback when the user clicks on the bubble. Audio-visual media can begin automatically playing in the main content box portion of the display. In yet another embodiment, the identity of a merchandise bubble is stored with a reference to the user so that when the user exits the event or the event terminates, the merchandise represented by the merchandise bubbles that the user interacted with is presented to the user with the option to purchase the item. In yet another embodiment, the user is presented with links to locations to either view the item further, for example, the webpage of the manufacturer of the merchandise, or a third party retailer that provides a point of purchase of the item.

Moderator to User bubble Interaction. The system permits a moderator of the media event to control the event and the attendees of the event. For example, the system can allow a moderator, who may be a celebrity or the performing artist, to view an array of user bubbles and to select, from these users, one or more users to video-chat or text chat with. This would could occur prior to, during or after the media event is taking place.

Real-Time polling Display. In another embodiment, the system can provide a live broadcast and its unique interface allows moderators to poll the audience and get a visual display of the results of the poll in real-time. In addition, the user characteristic data can be used by the system to get specific marketing or demographic data about the users who voted on the content in order to better understand the outcome. The polling results can be used as a filter variable for which users are selected to be viewable in the space. For example, any user that voted yes to the polled question can be rewarded by having their bubble avatar included in the display.

Uploading Polls. The system can present the users of a given event questions that amount to a poll. In one embodiment, the system obtains real-time results by polling the users attending an event in real time. In yet another embodiment, the polling question is formulated to have two possible answers. As users click on their selected answer, their bubble is moved to the right or left of the screen in accordance with the selection.

Advertisement bubbles. The use of the bubble avatar to display media content provides a mechanism for advertising. Advertising revenue can be based not only on the number of clicks on the advertising bubble, but also on the total number of viewers and the amount of time the bubble appears on the screen during the event. In one embodiment, the number of users who are viewing an event times the amount of time the advertising bubble appeared on the screen is the metric used to charge for advertising.

Real-Time Ad targeting via a Ranking Algorithm. The user's data and ranking may be used for targeting advertising. Real-time advertising carries relevance and currency that stands out from the crowd. It becomes specific, accurate, and meaningful instead of generic and lacking in urgency. For even greater efficiency, the system data regarding user characteristics and behavior can be used as raw input to calculations that select which advertising content should be displayed.

Post Event Interaction. When the media event concludes, or when the user exits the event, the screen will switch to another screen that offers objects for purchase. In one embodiment the follow-on screen presents an iTunes™ purchase button, in another, the screen presents any giveaway gifts that the user has won and in a third, the screen presents merchandise associated with the media event that are for sale. All connections made between users are saved into a database when the event ends and gives the user the option to add to those connections, or add the connections to their commercial third party social network service. References to items selected through the user's interaction with advertising or merchandise bubbles are saved into a collection or shopping cart data structure associated with the user so that when event is over, or when the user exits the event, the user is presented with an interface screen that they can use to complete purchases or find out more information about the items. Information about the items may be provided by text, image, hyperlink, video or audio or combinations thereof. In addition, there will be a small shopping cart icon on the interface that stores all content bubbles the user interacted with.

Operating Environment: In one embodiment of the system, there is a central server contains a data structure associated with the moderator. That data structure will also contain references to an event, the plurality of audience users that are logged into the event, the media content source for the event, the advertising bubbles for the event and the merchandise bubbles for the event. The audience users access the system by using their individual computer devices operating an Internet browser or other client code to view data feeds transmitted by the system. In one embodiment, the content box on the user environment window will typically be an iFrame (a dedicated area to nest content). This iFrame may display streams transmitted from remote servers,—both live and on demand. In other embodiments, the user environment has a variety of characteristics that may be optionally employed.

That data feed can include data related to data that the moderator has uploaded into the first subsystem and that is stored in the data structure associated with the moderator. The system can detect certain kinds of data input from the moderator. In one case, it can be an announcement from the entertainer. In another case, it can be a hyperlink to another location on the Internet. As a result, a data message is generated by the system that is transmitted to the list of users associated with the event. In another embodiment, the essential contents of the data message (or a reference to that information) is stored in the data structures associated with the users who are associated with the moderator.

The interactive network interface executes publicly available API's so that the social network profile of the incoming user is imported into the system. With the permission of the incoming user, this profile is shared out to the other social networking sites that are linked to the moderator so that the incoming user has a wider reach to all of the fans of the moderator. When the moderator transmits a chat message, it goes out onto all of the social networking sites that are linked to the moderator channel through the their external associated social network individuals or friends.

In yet another embodiment, each user has a share functionality that would permit them to activate a link that would be transmitted out to their selected external social network associates in order to invite them to view the moderator's event. By share functionality, it is meant any kind of transmission to a subscriber's associates in an external social network that essentially announces some activity taking place on the branded channel.

The system is typically comprised of a central server that is connected by a data network to a user's computer. The central server may be comprised of one or more computers connected to one or more mass storage devices. The precise architecture of the central server does not limit the claimed invention. In addition, the data network may operate with several levels, such that the user's computer is connected through a firewall proxy to one server, which routes communications to another server that executes the disclosed methods. The precise details of the data network architecture does not limit the claimed invention. Further, the user's computer may be a laptop or desktop type of personal computer. It can also be a video game console, a cell phone, smart phone or other handheld device. The precise form factor of the user's computer does not limit the claimed invention. In one embodiment, the user's computer is omitted, and instead a separate computing functionality provided that works with the central server. In this case, a user would log into the server from another computer and access the simulated space. In another embodiment, the user can operate a local computer running a browser, which receives from a central server a video stream representing the rendering of the simulated space from the point of view associated with the user.

In this embodiment, the user computer captures the input of the user, e.g. audio input, video input and movement of the trackpad or other input device, and transmits this data to the server. The server then calculates a bitmap for each upcoming video frame using this revised data. The calculation includes a perspective rendering for each user, calculated at such user's virtual location. The Server then translates individual streams out to the individual users, each stream then having the perspective associated with the destination user.

This may be housed in the central server or operatively connected to it. In this case, an operator can take a telephone call from a customer and input into the computing system the customer's data in accordance with the disclosed method. Further, the user may receive from and transmit data to the central server by means of the Internet, whereby the user accesses an account using an Internet web-browser and browser displays an interactive web page operatively connected to the central server. The central server transmits and receives data in response to data and commands transmitted from the browser in response to the customer's actuation of the browser user interface. Some steps of the invention may be performed on the user's computer and interim results transmitted to a server. These interim results may be processed at the server and final results passed back to the user.

The invention may also be entirely executed on one or more servers. A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, TCP, UDP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory. The IO devices can include a display screen, loudspeakers, microphone and a movable mouse that indicate to the computer the relative location of a cursor position on the display and one or more buttons that can be actuated to indicate a command.

Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like. The computer can operate a program that receives from a remote server a data file that is passed to a program that interprets the data in the data file and commands the display device to present particular text, images, video, audio and other objects. The program can detect the relative location of the cursor when the mouse button is actuated, and interpret a command to be executed based on location on the indicated relative location on the display when the button was pressed. The data file may be an HTML document, the program a web-browser program and the command a hyper-link that causes the browser to request a new HTML document from another remote data network address location. The HTML can also have references that result in other code modules being called up and executed, for example, Flash or other native code.

The Internet is a computer network that permits customers operating a personal computer to interact with computer servers located remotely and to view content that is delivered from the servers to the personal computer as data files over the network. In one kind of protocol, the servers present webpages that are rendered on the customer's personal computer using a local program known as a browser. The browser receives one or more data files from the server that are displayed on the customer's personal computer screen. The browser seeks those data files from a specific address, which is represented by an alphanumeric string called a Universal Resource Locator (URL). However, the webpage may contain components that are downloaded from a variety of URL's or IP addresses. A website is a collection of related URL's, typically all sharing the same root address or under the control of some entity. In one embodiment different regions of the simulated space have different URL's. That is, the simulated space can be a unitary data structure, but different URL's reference different locations in the data structure. This makes it possible to simulate a large area and have participants begin to use it within their virtual neighborhood.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as C, C++, C#, Action Script, PHP, EcmaScript, JavaScript, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer. In one embodiment, the relational database uses cloud storage services such as Amazon SimpleDB, housed in one or more operatively connected servers operatively connected to computer memory, for example, disk drives. The invention may be executed on another computer that is presenting a user a semantic web representation of available data. That second computer can execute the invention by communicating with the set of servers that house the relational database. In yet another embodiment, the initialization of the relational database may be prepared on the set of servers and the interaction with the user's computer occur at a different place in the overall process.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention as defined by the following claims.

What is claimed:

1. A system comprised of one or more computers operatively connected using a data network for transmitting data comprising a media event to a plurality of user's computers, said system comprised of a transmitting component that is adapted to transmit data messages, said data messages containing data corresponding to at least one avatar, so as to cause each of the user's computers to present the event on the user's computer display and simultaneously display the at least one avatars, said avatars representing the other users who are authorized to receive the same media event.

2. The system of claim 1 further comprising a selection component adapted to select a subset of the users authorized to view the media event and to cause the transmission component to restrict transmission of the data messages corresponding to avatars to those avatars associated with the selected users.

3. The system of claim 2 where the users are selected on the basis of a filter setting selected by a user and said restricted transmission being a transmission to the selecting user's computer device.

4. The system of claim 3 where the restricted transmission is comprised of data for at least one avatars that meet the data filter requirements of the receiving user while at the same time the receiving user's attributes satisfy the filter requirements corresponding to the users associated with the at least one avatars.

6. The system of claim 1 further adapted to transmit avatars comprised of advertising.

7. The system of claim 1 where the system is further adapted to transmit avatars comprised of information related to merchandise that may be purchased.

8. The system of claim 1 where the system is further adapted to transmit avatars comprised of information related to media products.

9. The system of claim 1 further comprising a communication component that is adapted to receive data from a first user's computer representing a selection of a second user whose avatar is displayed on the first user's computer and transmit a data message representing a chat request to the second user, and further adapted to receive a data message representing a response to the request from the second user's computer.

10. The system of claim 1 further comprising a moderator component that is adapted to receive commands from an authorized moderator, the receipt of said commands causing the system to select a data source for the media event and set a start time for transmission of the media event and to store the selection and setting in a data structure associated with the event.

11. The system of claim 10 where the moderator component is further adapted to receive commands from the authorized moderator that cause the system to select at least one avatar that is caused to be displayed on all of the user's computers who are authorized to access the transmission of the media event.

12. The system of claim 11 where the selected avatar is an advertising avatar.

13. The system of claim 11 where the selected avatar is a media avatar.

14. The system of claim 11 where the selected avatar is a merchandise avatar.

15. The system of claim 10 where the moderator component is adapted to receive from an authorized moderator a selection of a user and to initiate a bi-directional communication channel between the moderator component and the user's computer.

16. The system of claim 2 further adapted to retrieve from a data storage device data representing at least two attributes of at least one user and to use as the selection filter a rank calculation using the retrieved data.

17. The system of claim 16 further adapted to select advertising for display on at least one of the users' computers by means of using the result of the rank calculation.

18. The system of claim 1 further comprising a post event component that retrieves from a data storage device data representing a record of interactions between at least one user and either an advertising avatar, media avatar or merchandise avatar, said post event component adapted to use the retrieved interaction data to transmit to the user's computer data representing an offer to purchase at least one of the items referenced by the received interaction data.

19. The system of claim 2 further adapted to transmit to a user's computer data representing the de-selection of avatars already appearing on said user's computer so as to cause the user's computer to stop displaying the deselected avatars, said deselection resulting from the application of the filter.
